(19) United States
(12) Patent Application Publication
(10) Pub. No.: US 2014/0082117 A1
(43) Pub. Date: Mar. 20, 2014

(54) CLIENT DEVICE LOCKDOWN AND CONTROL SYSTEM

(71) Applicant: ConnectEDU Inc., Boston, MA (US)

(72) Inventors: Sudeep Prabhakar Unhale, Newton, MA (US); Rick Blaisdell, Stratham, NH (US); Christopher Jay Davia, Madison, CT (US)

(73) Assignee: ConnectEDU Inc., Boston, MA (US)

(21) Appl. No.: 14/026,136

(22) Filed: Sep. 13, 2013

Related U.S. Application Data
(60) Provisional application No. 61/701,278, filed on Sep. 14, 2012.

(51) Int. Cl. H04L 29/08

(52) U.S. Cl. CPC H04L 29/08135
USPC 709/208

(57) ABSTRACT

A method of controlling a plurality of slave devices includes receiving, at a master device, a connection request from each slave device in the plurality of slave devices, where the connection request is sent from a wrapper application executing on each slave device, and authenticating the connection request from each slave device. The method further includes sending, from the master device, an authorization acknowledgement to the wrapper applications of an authorized set of slave devices in the plurality of slave devices. The method further includes sending a first command from the master device to the authorized set of slave devices, where the first command allows the execution of a first application on each slave device in the authorized set of slave devices, and monitoring the execution of the first application on each slave device.

### CROSS REFERENCE TO RELATED DOCUMENTS

This application claims priority under 35 U.S.C. §119(e) to U.S. provisional patent application No. 61/701,278, filed Sep. 14, 2012, entitled “CLIENT DEVICE LOCKDOWN AND CONTROL SYSTEM,” and naming at least Sudeep P. Unhale as inventor. The disclosure of this provisional patent application is incorporated by reference herein in its entirety.

### FIELD OF THE APPLICATION

The application generally relates to systems and methods for providing a control system for a set of electronic devices. More specifically, the application relates to wrapper applications installed on a number of slave devices, where the wrapper application facilitates communication with a master device and allows the master device to control aspects of the slave devices.

### BACKGROUND

Electronic devices, such as desktop computers, laptop computers, tablet computers, smart phones, or other computational devices provide users with the ability to execute a number of applications on the devices to perform specific functions. Some applications may utilize overlapping sets of data. For example, education-oriented applications or career-oriented applications may utilize much of the same data relating to the user of the applications, such as transcript information, educational or career history, and biographical information. However, software applications for electronic devices may be developed by a number of independent parties, such as companies and school organizations. These independent applications do not have built-in data sharing capabilities amongst themselves, so the same data must be added or changed manually across all applications that use the data. In addition, information regarding a person's education, career, or other biographical information is highly sensitive and privacy problems may arise when attempting to share data among independent applications in an open environment.

It may also be useful to control access to one or more applications running on multiple electronic devices in certain settings. For example, students inside a classroom may use electronic devices as teaching tools to look up information online or run specially developed educational software applications at the direction of a teacher. These applications may include presentation or word processing applications, electronic encyclopedias, quiz programs, and games or other entertainment-related programs. However, electronic devices may also be a source of distraction for students. Students may use the devices for personal entertainment rather than following the lesson plan. The teacher cannot effectively monitor or control all the applications the students use on the electronic devices. This problem also exists in other settings where a number of people operate the same applications on electronic devices concurrently, such as within a company, in the military, or in a hospital. Thus there exists a need to provide a unified control system to manage the operation, data storage, and data-sharing aspects of applications running on multiple electronic devices.

### SUMMARY

To provide a control system for a set of electronic devices, one or more electronic devices are designated as a master device that controls other devices, termed slave devices. The master device may be one or more servers, while the slave devices may be desktop computers, laptop computers, tablets, smartphones, or other electronic devices. Each slave device has a native operating system installed by the manufacturer or vendor of the device. A wrapper application provided by the master device is installed on each slave device. The wrapper application overlays the native operating system of the slave device and communicates with the master device. A user provides log-in information to the wrapper application, which passes the log-in information to the master device. The master device authenticates each user that requests a connection to the master device, and also authenticates the slave device that the user uses to connect to the master device. The master device provides a selection of applications executable on the slave device, where the applications provided may depend on the identity of the user and the slave device. The wrapper application controls access to the applications, which may include locking certain applications, disallowing execution under certain conditions, and communicating data between the applications and the master device. A slave device may request that the master device control a set of other slave devices. The master device then sends control commands to the wrapper application of each slave device in the set, and receives operational information from each wrapper application regarding the state of the slave device. This allows simultaneous and real-time control of the set of slave devices. The wrapper application also facilitates data access between the slave device and the data store on the master device. The master device may allow multiple applications on the slave device to access and write to user data on the data store. In this manner, the master device provides a way to control and monitor applications and other functionality on a set of slave devices.

One aspect described herein discloses a system for controlling a slave device. The system includes a data store configured to store user data and an application database, and being in communication with a master device. The system also includes a master device having a communication platform configured to communicate with a slave device, where the slave device is associated with a device unique identifier and is operated by a user, and a control platform. The control platform is configured to provide the slave device with a plurality of applications selected from the application database based on the device unique identifier and an identity of the user, and a wrapper application to be executed on the slave device for receiving control commands from the control platform to control the user's access to the plurality of applications and for communicating information between the plurality of applications and the data store.

Another aspect described herein discloses a method of controlling a plurality of slave devices. The method includes receiving, at a master device, a connection request from each slave device in the plurality of slave devices, where the connection request is sent from a wrapper application executing on each slave device, and authenticating the connection request from each slave device. The method further includes sending, from the master device, an authorization acknowledgement to the wrapper applications of an authorized set of slave devices in the plurality of slave devices. The method further includes sending a first command from the master device to the authorized set of slave devices, where the first command allows the execution of a first application on each slave device in the authorized set of slave devices, and monitoring the execution of the first application on each slave device.

Another aspect described herein discloses a method of data sharing among a plurality of applications executing on a slave device. The method includes receiving, at a master device, a data write request from a wrapper application executing on the first slave device, where the data write request originates from a first application on the first slave device and includes a portion of information, and authorizing the data write request from the wrapper application, where the portion of information is stored in a data store by the master device and associated with the user. The method further includes receiving, at the master device, a first data read request from wrapper application, where the first data read request originates from a second application on the first slave device and includes a request for the portion of information, and authorizing the first data read request from the wrapper application, where the master device sends the portion of information stored in the data store to the wrapper application.

Another aspect described herein discloses a method of providing an application platform for a slave device, where the method includes sending from a master device to the slave device a wrapper application to be executed on the slave device and generating a device unique identifier associated with the slave device. The method further includes receiving user identification information from the wrapper application on the slave device, where a user on the slave device inputs the user identification information to the wrapper application. The method further includes selecting a plurality of applications from an application database stored on the master device, where the selection is based on the user identification information and the device unique identifier, and sending the plurality of applications to the slave device.

### BRIEF DESCRIPTION OF THE FIGURES

The methods and systems may be better understood from the following illustrative description with reference to the following drawings in which:

FIG. 1 shows a master device for controlling a set of slave devices in accordance with an implementation as described herein;

FIG. 2 shows illustrative components of a master device in communication with a slave device in accordance with an implementation as described herein;

FIG. 3 shows a flow chart for a master device sending a control command to a slave device in accordance with an implementation as described herein;

FIG. 4 shows a diagram for communication between applications executing on slave devices with a master device in accordance with an implementation as described herein;

FIG. 5 shows a graphical user interface on a slave device for accessing applications controlled by a master device in accordance with an implementation as described herein;

FIG. 6 shows another graphical user interface on a slave device for accessing applications controlled by a master device in accordance with an implementation as described herein;

FIG. 7 shows a method of simultaneously controlling a plurality of slave devices in accordance with an implementation as described herein;

FIG. 8 shows a method of data sharing among a plurality of applications executing on a slave device in accordance with an implementation as described herein; and

FIG. 9 shows a method of providing an application platform for a slave device in accordance with an implementation as described herein.

### DETAILED DESCRIPTION

To provide an overall understanding of the systems and methods described herein, certain illustrative embodiments will now be described. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. In particular, a master device, server, service, or system as used in this description may be a single computing device or multiple computing devices working collectively and in which the storage of data and the execution of functions are spread out amongst the various computing devices.

Aspects of the systems and methods described herein allow a master device to interact with and control applications and other functions on one or more slave devices. The master device may be one or more servers, while the slave devices may be desktop computers, laptop computers, tablets, smartphones, or other electronic devices. Each slave device has a native operating system installed by the manufacturer or vendor of the device. A wrapper application provided by the master device is installed on each slave device. The wrapper application overlays the native operating system of the slave device and communicates with the master device. A user may log into the wrapper application on the slave device. The master device authenticates each user that requests a connection to the master device, and also authenticates the slave device that the user uses to connect to the master device. The master device provides a selection of applications executable on the slave device, where the applications provided may depend on the identity of the user and the slave device. The wrapper application controls access to the applications, which may include locking certain applications, disallowing execution under certain conditions, and communicating data between the applications and the master device. A slave device may request that the master device control a set of other slave devices. The master device then sends control commands to the wrapper application of each slave device in the set, and receives operational information from each wrapper application regarding the state of the slave device. This allows simultaneous and real-time control of the set of slave devices. The wrapper application also facilitates data access between the slave device and the data store on the master device. The master device may allow multiple applications on the slave device to access and write to user data on the data store. In this manner, the master device provides a way to control and monitor applications and other functionality on a set of slave devices.

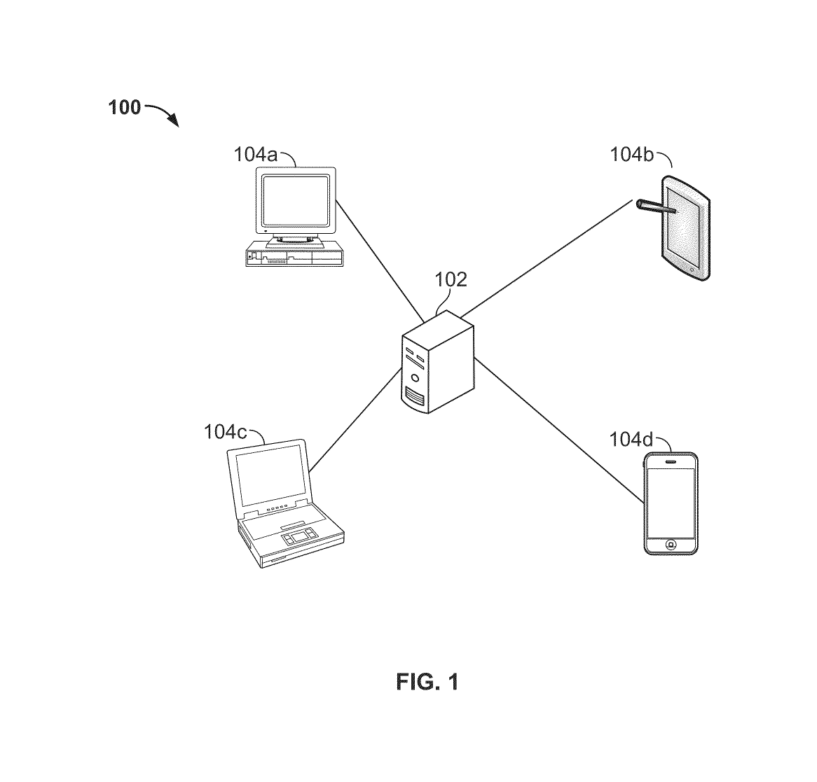

A master device handles communications with one or more slave devices. A general master device and slave device system 100 is shown in FIG. 1. System 100 includes master device 102 and a number of slave devices 104a through 104d. Master device 102 may be one or more servers, but may also be any other electronic device that handles connections with multiple slave devices. Slave devices may be desktop computers such as device 104a, tablet computers such as device 104b, laptop computers such as device 104c, or handheld and portable computing devices such as device 104d, or any other type of computational device. Slave devices may encompass a number of commercially available consumer electronics. There may be additional slave devices that connect to master device 102. Slave devices 104a through 104d may communicate with master device 102 through a variety of means, such as through a local area network (LAN), wide area network (WAN), an wired Internet connection, cellular data connection, microwave communication, fiber optics, or any other type of network connection. Master device 102 may encompass one or more electronic devices working collectively to control the slave devices. For example, master device 102 may include a gateway server for monitoring connections with slave devices 104a and 104d and additional servers for storing data.

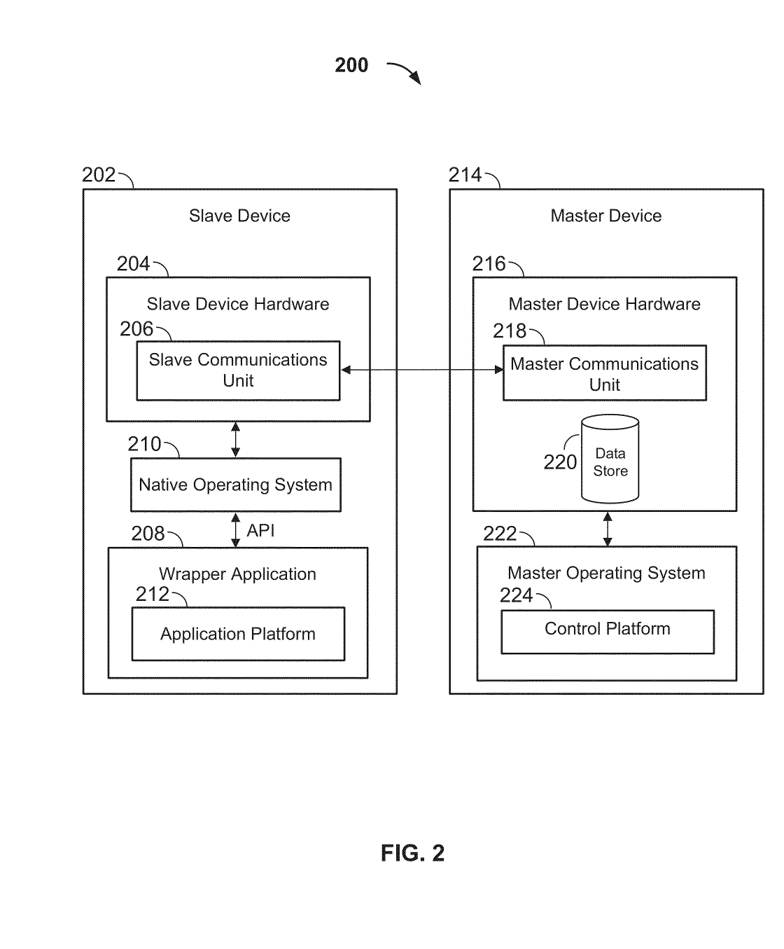

The components of a master device and a slave device that connects to the master device are illustrated in system 200 of FIG. 2. System 200 includes a slave device 202 in communication with a master device 214. The slave device 202 has slave device hardware 204, which includes slave communications unit 206. Slave communications unit 206 may be any type of wired or wireless network communications hardware that allows slave device 202 to communicate with master device 214. Slave device hardware 204 may include other components such as processors, memory, bus, and input/output devices. Slave device 202 has a native operating system 210 which is installed by the manufacturer or vendor of the slave device. Examples of native operating systems include the ANDROID® operating system, offered by Google Inc. of Mountain View, Calif., the iOS® operating system, offered by Apple Inc. of Cupertino, Calif., and the Windows® operating system, offered by Microsoft Corporation of Redmond, Wash.

A wrapper application 208 is installed on slave device 202 that overlays the native operating system. Wrapper application 208 may be installed by downloading it from master device 214. Slave device 202 may be assigned a unique identification, such as a serial number, by master device 214 when wrapper application 208 is installed. Wrapper application 208 acts as an intermediate processing layer between master device 214 and native operating system 210 and slave device hardware 204 of slave device 202. Master device 214 may control certain software and hardware functions on slave device through wrapper application 208. Wrapper application 208 uses kernel software and application programming interfaces (APIs) to communicate between the wrapper application and native operating system 210. The API specifies how components and functions in wrapper application 208 and native operating system 210 should interact. This allows wrapper application 208 to initiate communication with master device 214 through the slave device, send and receive commands from master device 214, and implement control commands on slave device 202 sent by master device 214. The API of native operating system 210 is one or more files that declare functions, objects and other data structures that native operating system 210 makes available to developers, as well as the inputs and outputs for functions, object parameters, and other information necessary for utilizing the functions and data structures. Wrapper application 208 may also have an API file that declares functions and data structures used by wrapper application 208. This allows native operating system 210 and wrapper application 208 to call each other's functions, process the inputs and outputs of those functions, and use each other's data structures.

For example, an API file belonging to wrapper application 208 may contain a declaration of a getUserID function that returns a string representing the unique identifier of a user on the slave device. Master device 214 sends slave device 202 a user ID request for the user on the slave device. Native operating system 210 references the API file of wrapper application 208 to identify the getUserID function and call it, which returns an output that slave device 202 sends to master device 214. In another example, the API of native operating system 210 may define a function displayApp for displaying the icon of an application on slave device 202, and takes as input an application identifier. Master device 214 sends a command to slave device 202 to grant the user access to an application with a specific application identifier. The native operating system 210 passes the command to wrapper application 208 through the API. Wrapper application 208 processes the command and uses the displayApp function declared in the API to instruct native operating system 210 to display the icon of the application to the user. Other commands declared in the API file may allow wrapper application 208 to block the execution of applications, set limits on the time and location applications can be accessed, control slave device hardware 204 settings, and other commands to control aspects of slave device 202.

The API is provided by the manufacturer of native operating system 210 and determines the amount of control that wrapper application 208 (and thus master device 214) has over the native operating system. For example, native operating system 210 may be developed as an open source system and thus give third party developers access to all or nearly all of the kernel software or APIs of the native operating system. This allows master device 214 to control the software applications on slave device 202 and much of slave device hardware 204, such as sound, camera, screen, and input/output connections. If native operating system 210 is proprietary and gives third party developers limited access to the kernel software or APIs, then wrapper application 208 may only be capable of running certain programs on slave device 202 and may obtain data from a limited number of other applications. Wrapper application 208 may not be able to control much, if any, of slave device hardware 204. Wrapper application 208 is written in any programming language compatible with the native operating system of slave device 202, such as Java, .NET Framework, or any scripting or software instruction language or medium. An example of an API is the Android Interface Definition Language (AIDL) that allows developers to utilize functions and data structures on the ANDROID® operating system. Because slave devices have various operating systems installed on them, multiple wrapper applications and APIs may be developed that each work with different types of operating systems.

Wrapper application 208 may also provide its own API so that it can communicate with applications executing on slave device 202. The API specifies how components and functions in wrapper application 208 and applications executing on slave device 212 should interact. For example, the wrapper application API may provide function declarations that allow applications to query the unique identifier of the user or device, or request log-in and authentication from master device 214. This allows applications to connect with master device 214 through wrapper application 208, and also allows master device 214 to send commands to the application.

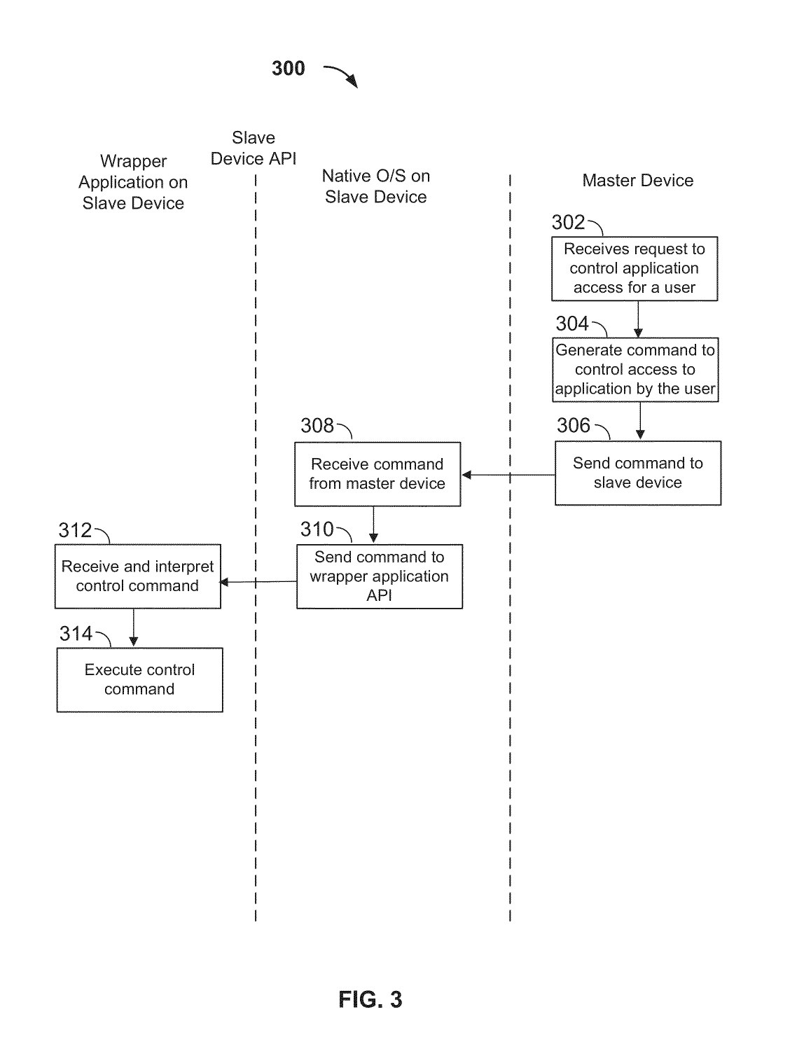

Flow chart 300 in FIG. 3 shows an example of how a master device uses a wrapper application installed on a slave device to control access to an application on the slave device. A master device first receives a request to control access to one or more applications for a user on a slave device, shown at 302. The request may come from another slave device, for example a teacher on another slave device sending a request to limit access to certain applications on a student's slave device, or the master device may determine from the user log-in information, user profile, and device unique identifier of the user's slave device which applications that the user is authorized to access. The request includes the unique identifier of the user, the unique identifier of the slave device, the unique identifier of the application, and one or more control parameters. The control parameter may be to prevent the user from initiating the application, prevent the user from terminating the application, or set time or location limits on when or where the application may be accessed. The master device generates a command to control access to the application according to the request, shown at 304. The command includes the unique identifier of the application to which the command will be applied. The command is formatted in a network protocol language that is compatible with the slave device.

After the command is formulated, the master device sends the command to the slave device, shown at 306. The master device looks up the network address of the slave device using the unique identifier of the slave device and sends the command over the network. The native operating system of the slave device receives the command, shown at 308. The native operating system send passes the command to the wrapper application through the API, shown at 310. The API converts the command into function calls and inputs that the wrapper application can process. The wrapper application receives the control command from the API, shown at 312. The wrapper application then executes the control command on the identified application, shown at 314. The control command may be directed towards the native operating system or the application itself. For example, if the command is to prevent initiation of the application, the wrapper application may communicate with the native operating system through the API stop the native operating system from executing the application. Or the wrapper application may communicate the command directly with the application through its own API. Thus the wrapper application acts as a processing layer that receives commands from the master device and implements the command on the slave device and any applicable applications on the slave device. While in flow chart 300 the control command applied to a specific application, the control command may also be applied to the native operating system or device hardware in a similar fashion.

Wrapper application 208 in FIG. 2 also provides an application platform 212 for the user of slave device 202. Application platform 212 includes a user interface that displays one or more applications provided by master device 214. An application displayed by application platform 212 is executed by slaved device 202 when a user selects the application. Wrapper application 208 may control access to the application, such as allowing execution of the application, showing or hiding the display of the application icon in application platform 212, terminating the application, pausing the application, changing application settings, and handling data communication between the application and master device 214. These applications may be commercially developed by a number of companies and provided to slave device 202 for specific use with wrapper application 208 and master device 214. For example, applications may be purchased or downloaded from an online application store provided by master device 214. The applications may also be permanently stored on slave device 202 after download or may be loaded from master device 214 each time the user logs into application platform 212. These applications may all relate to one or more subject matters or themes, for example education-oriented applications, career-oriented applications, or other context specific applications. Master device 214 fully or partially controls access to the applications in application platform 212 in conjunction with wrapper application 208. For example, master device 214 may send control commands or instructions via wrapper application 208 to allow or block access to one or more applications executing on application platform 212. Wrapper application 208 receives the control commands from the API of slave device 202 and applies the command to the appropriate application. The applications may also read data from data store 220 on master device 214 or write data to data store 220 through wrapper application 208. Wrapper application 208 may also provide certain security features for slave device 202. For example, the wrapper application may require login information before a user is allowed to operate the wrapper application and access the application platform, may allow the master device to terminate applications or shut down certain device hardware, or prevent access to the native operating system or the device settings.

Master device 214 has master device hardware 216, which includes master communications unit 218 and data store 220. Master communications unit 218 may include a number of physical ports, which each physical port capable of supporting multiple virtual ports, like server ports. The master communications unit 218 and slave communications unit 206 communicate with each other using a standard network protocol, such as TCP/IP. To initiate communication, slave device 202 may send a connection request to master device 214, or the master device may send a connection request to slave device 202. Slave device 202 and other slave devices may connect to master device 214 by addressing one of the ports of the master device, such as through a specific port number. The wrapper application of each slave device may include a directory of port numbers or IP addresses for one or more master devices. Master communications unit 218 maintains connections with all or a relevant subset of the slave devices that query it and may send messages or commands through its ports. For example, master device 214 may utilize virtual software ports to send the same message to a set of slave devices. The virtual ports link multiple IP addresses to the same physical port, and each virtual port shares the same network settings. This allows master device 214 to coordinate sending messages to multiple devices using only one port. Messages that may be sent between master device 214 and slave device 202 include connection requests, authorization and authentication requests, acknowledgement messages, control commands from the master device, data access requests, and commands from the master device to install software upgrades or applications on the slave device. Messages exchanged by master device 214 and slave device and 202 may be encrypted. Master device hardware 216 may include other components such as processors, memory, bus, and input/output devices.

Master device 214 also includes data store 220, which stores user data for a number of users. User data for a particular user may be accessible by multiple applications executing on slave device 202 and operated by that user. For example, data store 220 may store education-oriented information for multiple user accounts. A grade analysis application executing on slave device 202 may query master device 214 for grade information for a particular user stored on data store 220. Master device 214 grants the application access to the information if the slave device presents correct authentication information (e.g. the correct user name and password for that user and correct authentication information for the slave device and the application). Data store 220 may also store various versions of wrapper application 208 that are installed on slave device 202. Different versions of the wrapper application may be necessary depending on the different native operating systems running on slave device 202. Data store 220 may also store an application database. When a user logs into master device 214 using slave device 202, master device 214 may provide a subset of the applications found in the application database to slave device 202. This selected set of applications are placed in application platform 212 and executed by wrapper application 208. The set of applications provided is based on the identity of the user and the slave device. Although data store 220 is illustrated within master device 214 in FIG. 2, data store 220 may also be a stand-alone memory storage system that master device 214 may access. Data store 220 may be implemented using non-transitory computer-readable media. Examples of suitable non-transitory computer-readable media include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and readable, once-writeable, and re-writeable CD and DVD disks.

Master device 214 also has a master operating system 222 which runs control platform 224. Control platform 224 controls and monitors slave devices that connect with master device 214. A user on slave device 202 may connect with master device 214 through slave communications unit 206. The user provides unique identification information to master device 214, such as a user name and password. Control platform 224 authenticates the user's identification information to verify that the user has an account with master device 214. Data store 220 may store user profiles that control platform 224 may use to verify a user's authentication information. The user profile may store information such as the user's biographical or demographic information, academic information, professional or career information, health information, financial information, resume and skills information, usage history information of applications, a user's associations with various entities such as schools and places of employment, a user's relationship with other users (e.g. student/teacher, or parent/child), and a user's relationship with various slave devices (e.g. home computer, school tablet). User profile data may be entered by the user, collected from applications that the user has used, or from external data sources that control platform 224 may access.

Control platform also authenticates slave device 202 as a registered device, which may have a unique device unique identifier number or other identification associated with it. The device unique identifier and user identification information may be sent by wrapper application 208 when a user attempts to log into master device 214. Once the control platform authenticates both the user and slave device, control platform 224 determines which applications in the application database stored on data store 220 are available to the user. This may depend on the identity of the user or the slave device, the user's relationship with the slave device or a certain entity or person, or the context in which the user is connecting to master device 214. Thus different rules and permissions may apply to the same user depending on the specific circumstances at the time of access. For example, if slave device 202 only allows wrapper application 208 limited access to the slave device, then control platform 224 may only provide applications to the user that do not exceed the limited access rights allowed by slave device 202. In another example, a user may access master device 214 through a personal home computer and a tablet provided by an organization, for example an educational organization or work environment, each with a unique identifier. Different applications may be available to the user when using the school tablet than when using the home computer. For example, control platform 224 may make testing software available to the user when using the school tablet but disallow the use of a web browser, and vice versa when the user is using his or her home computer. In another example, in an educational setting a user who is a teacher may authorize a number of student users to access only certain applications on slave devices provided by the educational organization for classroom purposes. Control platform 224 then determines whether the slave devices connecting to it match the user unique identifier of the students and the unique identifiers of the slave devices specified by the teacher, and limits each slave device accordingly. In another example, control platform 224 may use data associated with the user to determine appropriate applications to present to the user. For example, if data store 220 stores user profile information that the user has or will soon graduate from college, control platform 224 may begin to provide career-oriented applications to the user.

Control platform 224 also monitors and controls aspects of slave device 202. Control platform 224 may collect information from applications executing on slave device 202 through wrapper application 208. Wrapper application 208 handles communication between one or more applications in application platform 212 and control platform 224. For example, wrapper application 208 may send control platform 224 information about which applications on application platform 212 are currently executing and the length of time the applications have been executing, as well as other data on usage, output, and any other relevant application events for which the application manufacturer provides access. This information is accessed through the API of native operating system 210. Control platform 224 receives information sent by slave device 202 and stores the information on data store 220, or may send information stored on data store 220 to a requesting slave device. Control platform 224 also sends commands to control access to applications on slave device 202 through wrapper application 208. Control commands may include commands to allow, block, lock, pause, or terminate applications. Control platform 224 may lock applications based on a predetermined requirement. For example, control platform 224 may specify that an application may be executed only at certain locations, determined through geolocation methods such as GPS on the slave device. In another example, control platform 224 may allow an application to execute for a predetermined amount of time or specifying certain time and days on which the application may be executed. Other predetermined requirements may be specified by a user of the slave device or master device. The control commands are applied to the applications by wrapper application 208 calling functions found in the API of native operating system 210. Control platform 224 may also control other functions and hardware on slave device 202 depending on the extent of control native operating system 210 gives over its kernels or APIs to third party developers.

Control platform 224 allows master device 214 to monitor and control any number of slave devices and the applications executing on the slave devices, where each slave device has a wrapper application 208 installed. Control commands may be sent to the wrapper application of one or more slave devices simultaneously, where the commands are processed by the wrapper application and applied to an application executing on each slave device. For example, in the classroom setting the teacher and students may each possess a slave device controlled by master device 214. Each slave device is logged into control platform 224 so that master device 214 may identify the students and the slave devices they are using, as well as identify the teacher and his or her slave device. The teacher may use his or her slave device to request the master device to allow initiation of a quiz application on each student's slave device. The master device allows the initiation of the quiz application on each slave device and may send the teacher answers given by the students in real time. The master device may also lock down or terminate the quiz application after an allotted period of time so that students may no longer answer questions. The master device may also initiate actions on a subset of the slave devices. For example, if some students finish the quiz before others, the master device may direct those students to a next activity or application. The master device may also lock down other applications on the slave device so that the students may not access those applications during the quiz.

In conjunction with wrapper application 208, control platform 224 also allows data sharing among applications executing on slave device 202. For example, after slave device 202 is authorized to communicate with master device 214, an application on slave device 202 may request that master device 214 save a user's home address. This request is routed through wrapper application 208, which communicates with master device 214. Wrapper application 208 sends control platform 224 the information to be saved and the corresponding user account to save the information under, as well as information about the application itself, such as a unique identification number. Control platform 224 uses the unique identifier of the application to check whether the application is allowed to save information about the user, and if so stores the information in data store 220. At a later time, another application on slave device 202 may request master device 214 for the user's home address. This request is routed through wrapper application 208 and passed on to control platform 224. Control platform 224 checks whether the subsequent application is allowed to access this data for the particular user, and if so sends the data back to wrapper application 208, which then passes the data to the requesting application. Control platform 224 may maintain an access control list or another access lookup table to determine data rights for various applications, users, and slave devices. Thus control platform 224 provides unified data storage and sharing to a number of applications executing on slave device 202.

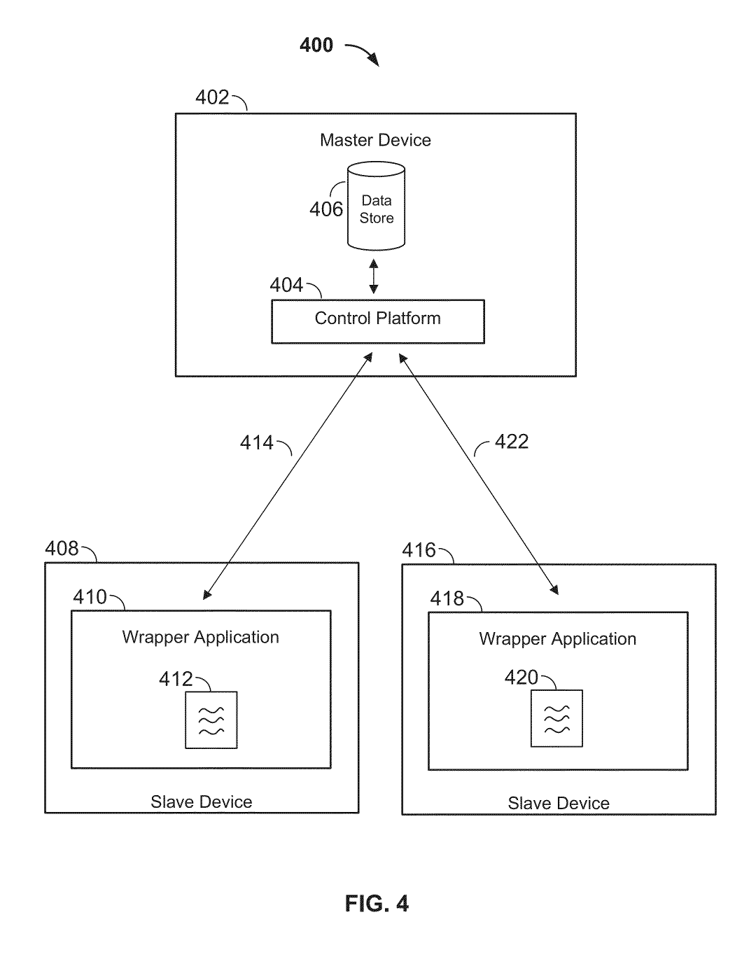

The communication flow between the master device and one or more slave devices is now described. FIG. 4 shows a master-slave system 400 which includes master device 402 and slave devices 408 and 416. The master device and slave devices are connected through a remote network, such as the Internet. Master device 402 may be connected with additional slave devices not illustrated in FIG. 4. Master device 402 includes a control platform 404 and a data store 406, as well as other components described in FIG. 2 but not herein illustrated in FIG. 4. Slave devices 408 and 416 each include wrapper applications 410 and 418 respectively. Application 412 is executing on slave device 408, and likewise application 420 is executing on slave device 416. Applications 412 and 420 are provided by the master device. Slave devices 408 and 416 have other components not illustrated in FIG. 4, such as the components described in relation to FIG. 2. Communications link 414 connects wrapper application 410 with control platform 404, while communications link 422 connects wrapper application 418 with control platform 404. The wrapper applications use the APIs of the respective slave devices to communicate with the native operating systems on those slave devices. This allows the wrapper applications to communicate with master device 402 and to call functions that affect the execution of applications 412 and 420.

Wrapper applications 408 and 416 may provide users with a login prompt for logging in to master device 402. When the users input login information using the slave devices, such as a username and password, wrapper applications 408 and 416 communicate the login information to control platform 404 through communication links 414 and 422 respectively. Wrapper application 408 and 416 may also communicate the device unique identifiers for their respective slave devices to control platform 404. Control platform 404 authenticates the user login information and device unique identifier received from each slave device. Control platform 404 then provides each slave device with a selection of applications from an application database stored in data store 406. The selected applications may be selected based on the identity of the user and the device unique identifier. The selection of applications provided to slave device 408 includes application 412, while the selection of applications provided to slave device 416 includes application 420. Wrapper applications 408 and 416 receive the selection of applications from control platform 404 and display the applications for users, for example as icons.

A user on slave device 408 may initiate application 412 by selecting its icon. Wrapper application 410 then passes a command to initiate application 412 to slave device 408. While application 412 is executing, wrapper application 410 may process data communications between application 412 and control platform 404. For example, if application 412 needs to read data stored on data store 406 or write data to data store 406, application 412 generates a data request to wrapper application 410. Wrapper application 410 forwards this request, along with the application unique identifier for application 412, to control platform 404 through communications link 414. Other information such as the application version number, device unique identifier, and user unique identifier may also be provided. Control platform 404 authenticates the data request and then reads data from data store 406 or writes data to data store 406. Control platform may send the requested data (in the case of a read request) or a write confirmation (in the case of a write request) back to wrapper application 410. Wrapper application then passes the necessary data to application 412. Data communication for application 420 on slave device 416 is handled in a similar manner.

Control platform 404 may also simultaneously control access to applications on slave devices 408 and 416. For example, let applications 412 and 420 be copies of the same application. Control platform 404 may receive a request from another slave device to control access to certain applications on slave devices 408 and 416, identified by their device unique identifiers and application unique identifiers. Control platform then sends a control command to both slave devices 408 and 416 simultaneously through communication links 414 and 422. The wrapper applications of each respective slave device receive the control command and execute it. For example, the control command may be to allow execution of applications 412 and 420, in which case the wrapper applications both allow the initiation of the identified application. Other control commands may include commands to block execution of the applications, hide the applications from view, pause the applications, terminate the applications, determine a run time for applications, retrieve data from the applications, or to set data for the applications. Some control commands may not pertain to any particular application but pertain to the slave devices in general. For example, control commands may include commands to lock the slave device, to shut down the slave device, to determine the geolocation of a slave device, or to initiate other software or hardware related functionality. Control commands and data requests may be encoded in any known network protocol, such as TCP/IP. At the slave devices, wrapper applications 410 and 418 use the APIs of the respective slave devices to execute the control command from the master device at the native operating system level.

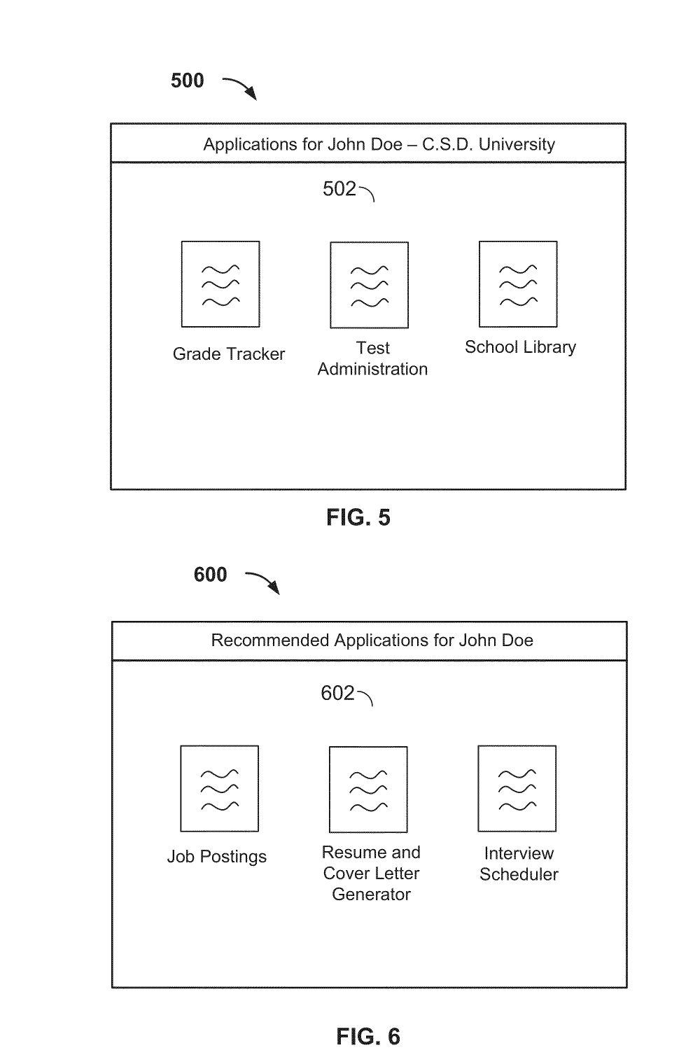

Examples of user interfaces for application platforms provided on a slave device by a master device are now described. FIG. 5 shows a graphical user interface (GUI) 500 of an application platform provided to user John Doe on a slave device, such as a desktop or laptop computer, a tablet, smartphone, or other electronic device. GUI 500 may be presented to the user after a wrapper application and a selection of applications is downloaded onto the slave device from the master device. GUI 500 includes a number of applications 502 that the user may access. Applications 502 are provided by the master device once a user has connected to the master device through the wrapper application. The type and number of applications that the user may have access to may depend on the identification of the user and the slave device. For example, if John Doe attends C.S.D. University and logs onto a slave device owned by C.S.D. University, the control platform on the master device recognizes that John Doe is a student of C.S.D. University and is using a school computer by checking John Doe's user profile and the device unique identifier of the slave device. The control platform provides John Doe with certain applications that have been approved by C.S.D. University, such as the “Grade Tracker,” “Test Administration,” and “School Library” applications. In an alternate example, John Doe from the previous example may bring a device that he owns to C.S.D. University. He may install the control program on his device or may be prompted to do so by school policy. The control platform on the master device recognizes that John Doe is a student of C.S.D. University and is using his own device. The control platform then provides John Doe with certain applications that have been approved by C.S.D. University, such as applications 502 in FIG. 5. C.S.D. University's device management strategy and configuration may influence the control platform on the master device.

The master device may also allow data storage and data sharing among the applications. For example, the “Test Administration” application may be used by John Doe to take an electronic quiz. After the quiz is complete, the “Test Administration” application communicates John Doe's quiz score to the wrapper application, which sends the quiz score and the “Test Administration” application unique identifier to the master device. The master device determines if the application is authorized to save grades onto John Doe's user profile, and then saves the grades into its data store. At a later time, John Doe may use the “Grade Tracker” application to access his past quiz scores. The “Grade Tracker” may generate a request for John Doe's past quiz scores. The wrapper application sends this request, along with the “Grade Tracker” application unique identifier, to the master device. The master device confirms that the “Grade Tracker” application is authorized to access John Doe's scores and sends the scores back to the wrapper application on the slave device. The data is provided to the “Grade Tracker” application and then displayed to the user. The master device may allow this type of data sharing even if both applications are produced by different third parties and don't communicate directly with each other.

FIG. 6 shows another example of an application platform GUI 600 provided on a slave device for the same user, John Doe. However, the slave device may be John Doe's personal home computer, not a computer owned by C.S.D. University. The master device, upon authenticating the device unique identifier of the home computer, may provide John Doe with a different set of applications 502 than shown in FIG. 5. For example, John Doe may have set his user profile to show that he is currently seeking a job. The master device may then provide a recommended set of career-related applications to John Doe, such as “Job Postings,” “Resume and Cover Letter Generator,” and “Interview Scheduler.” The control platform of the master device and the wrapper application of the slave device may also allow one or more of the applications to share data. Thus the master device, depending on the slave device that John Doe uses and John Doe's relationship with various entities or persons, may customize a set of applications to present to John Doe.

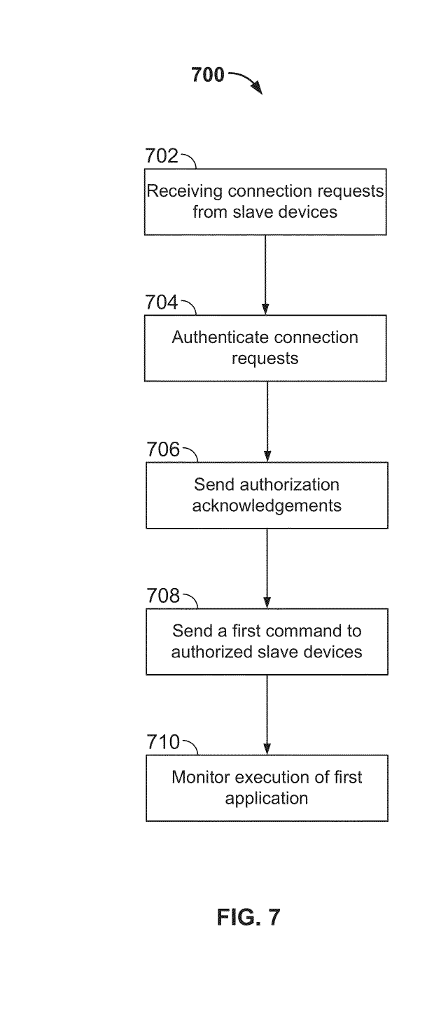

The control platform on the master device allows the master device to simultaneously control a set of slave devices, which includes controlling access to and monitoring the execution of an application executing on each slave device. A method of simultaneously controlling a plurality of slave devices is shown in FIG. 7. Method 700 includes receiving, at a master device, a connection request from each slave device in the plurality of slave devices, where the connection request is sent from a wrapper application executing on each slave device, and authenticating the connection request from each slave device. The method further includes sending, from the master device, an authorization acknowledgement to the wrapper applications of an authorized set of slave devices in the plurality of slave devices. The method further includes sending a first command from the master device to the authorized set of slave devices, where the first command allows the execution of a first application on each slave device in the authorized set of slave devices, and monitoring the execution of the first application on each slave device. Method 700 may be performed on any device or set of devices providing a control platform for a number of slave devices, such as master device 214 shown in FIG. 2.

Method 700 begins when a master device receives connection requests from a plurality of slave devices, illustrated as step 702. The connection request may include a unique identifier of the user of each slave device, for example an identification number or a user name and password. The connection request may also include a unique identifier for each slave device that connects to the master device, or a unique identifier and version number for an application on the slave device that attempts to connect to the master device. The slave devices communicate with the master device using a standard network protocol over any standard wired or wireless network connection, and the communications unit on the master device handles simultaneous connections with the slave devices. The connection request may include a request for the master device to control one or more applications executable on each slave device, the applications referenced using a unique identifier and may additionally be referenced by a version number. The connection request is sent by a wrapper application executing on each slave device, such as wrapper application 208 described in relation to FIG. 2. The wrapper application facilitates communication between the slave device and the master device.

The master device authenticates each connection request, shown as step 704. Authentication may include comparing the unique identifier of the user sent by each slave device to a list of authorized users who may connect with the master device. Authentication may also include authenticating the slave devices requesting connection to the master device using the device unique identifiers. Authentication may also include determining the scope of control that the master device has over the slave device. For example, the connection request may specify certain applications, as identified by unique application unique identifiers, be controlled by the master device. The master device may also determine the level of control from the user profile and the device unique identifier. For example, the master device may only control certain applications executing on the slave device, or the master device may control which applications are available on the slave device according to which slave device a user is using. Once the master device authenticates all the connection requests, the master device sends an authorization acknowledgement to the wrapper application of each slave device that is authorized to connect with the master device, shown as step 706. If some slave devices are not authorized to connect to the master device or if the authentication process fails, the master device may send a rejection message to the wrapper applications of those slave devices.

After the authorization acknowledgement is sent to the authorized set of slave devices, the master device sends a first command to the authorized slave devices, shown as step 708. The first command controls the execution of an application executable on each authorized slave device. The command may be to allow execution of the application, initiate a function or subroutine in the application, block execution of the application, hide the application from view, or pause or terminate the application depending on specified criteria, where one criterion may be time period, location perimeter, user criterion, time of day, business or organizational rules set by an organization owning the slave devices, or any other relevant variables or a combination of variables. For example, the commands sent from the master device may include commands to allow the execution of an application on each authorized slave device for a predetermined amount of time. When the predetermined amount of time has expired, the master device sends another command to terminate the application on each authorized slave device. The command may originate from another slave device, for example from a slave device that requests the master device to control another set of slave devices. This may occur, for example, in a classroom setting where a teacher requests that the master device initiates an action on slave devices used by students in the class. The command is received and processed by the wrapper application on each slave device using the API provided by the native operating system of each slave device. The command may also be an instruction to control the wrapper application itself, to control the hardware of the slave device, to update the wrapper application, or to update the policies for the user, device, or application on the slave device, or any combination thereof.

The master device also monitors the execution of the application on each authorized slave device, shown as step 710. Monitoring the execution of the application may include receiving input entered into the application by a user, timing the amount of time the application has been executing, determining the location of each authorized slave device, sending data to the application on each authorized slave device, auditing user behavior on each authorized slave device, or determining if any errors occurred while executing the application on each authorized slave device. The extent of monitoring the master device can achieve depends on the level of control a slave device gives to the wrapper application, and the design of the application itself. The wrapper application collects information regarding the execution of the application through the API of the native operating system and sends the information to the master device. The master device may store information obtained from the application in a data store, may associate the information with a user, or may present the monitoring information to an administrator or another slave device. In this manner, method 700 provides a method for simultaneous control of a plurality of slave devices.

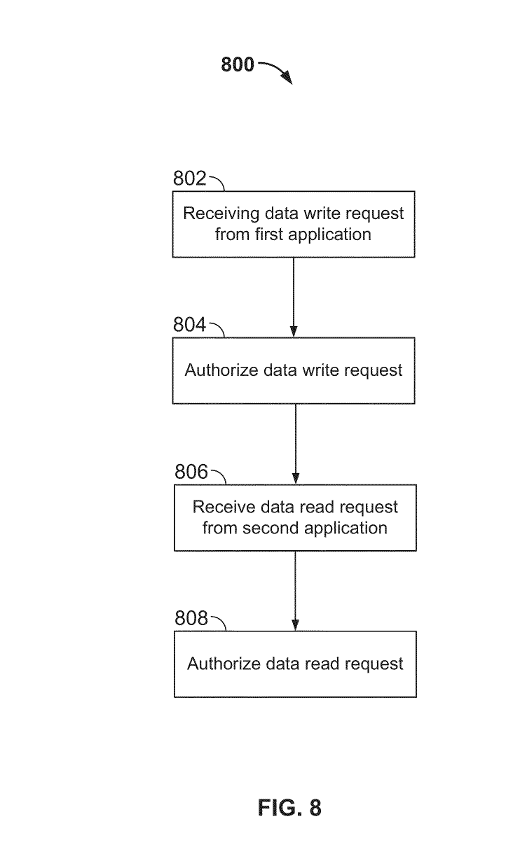

The control platform on the master device also allows the master device to provide data sharing among multiple applications executing on a slave device. Since the applications may be developed by various third parties, a centralized way of sharing data between the applications makes it easy for a user to store and load data when using these different applications. A method for data sharing among a plurality of applications executing on a first slave device is shown in FIG. 8. Method 800 includes the master device receiving a data write request from a wrapper application executing on the first slave device, where the data write request originates from a first application on the first slave device and includes a portion of information, and authorizing the data write request from the wrapper application, where the portion of information is stored in a data store by the master device and associated with the user. The method further includes receiving, at the master device, a first data read request from wrapper application, where the first data read request originates from a second application on the first slave device and includes a request for the portion of information, and authorizing the first data read request from the wrapper application, where the master device sends the portion of information stored in the data store to the wrapper application. Method 800 may be performed on any device or set of devices providing a control platform for a number of slave devices, such as master device 214 shown in FIG. 2.

Method 800 begins when a master device receives a data write request from a wrapper application on the slave device, illustrated as step 802. The data write request originates from a first application executing on the slave device. The request is routed through the wrapper application, which handles communication between the master device and applications on the slave device. The data write request includes a portion of information to be written, and may also include an identification of a user and an identification of the first application. The master device stores data for a number of users, so the identification of the user is used to determine which user the portion of information should be associated with. The identification of a user may be a unique identification number, a user name and password, or any other type of unique identifier. The identification of the first application may include the name of the application or any other unique identifier for that application, and may also include the version number. The data write request may also include identification of the slave device, for example a device unique identifier number. The wrapper application processes the data write request from the first application and sends it to the master device along with other information such as the user unique identifier, device unique identifier, or application unique identifier of the first application. The slave devices communicate with the master device using a standard network protocol over any standard wired or wireless network connection, and the communications unit on the master device handles simultaneous connections with the slave devices.

After the master device receives the data write request from the first application, the master device authorizes the data write request, as shown in step 804. The master device uses the identification of the user to determine if it stores information associated with that user. The master device also uses the application unique identifier to determine if the application is authorized to write data associated with the user. For example, some applications may only read data and other applications may not be authorized to access any data. The master device may also use the identification of the slave device to determine if the slave device is authorized to write data associated with the user. If the application is authorized, the master device writes the portion of information into a data store and associates the portion of information with the user. If the application is not authorized to write data to the data store, the master device may send an error message to the wrapper application on the slave device.

Sometime after the data write request is authorized, the master device receives a data read request from the wrapper application, shown as step 806. The data read request originates from a second application executing on the slave device. The data read request includes a portion of information to be read, and may also include an identification of a user and an identification of the second application. The master device stores data for a number of users, so the identification of the user is used to determined which user the portion of information is associated with. The identification of a user may be a unique identification number, a user name and password, or any other type of unique identifier. The identification of the second application may include the name of the application or any other unique identifier for that application, and may include the version number. The data read request may also include identification of the slave device, for example a device unique identifier number. Alternatively, the data read request may come from the same user on a different slave device. The wrapper application processes the data read request from the second application and sends it to the master device along with other information such as the user unique identifier, device unique identifier, or application unique identifier of the second application.

After the master device receives the data read request from the second application, the master device authorizes the data read request, as shown in step 808. The master device uses the identification of the user to determine if it stores information associated with that user. The master device also uses the identification of the second application to determine if the application is authorized to read data associated with the user. The master device may also use the identification of the slave device to determine if the slave device is authorized to read data associated with the user. If the application is authorized, the master device reads the portion of information associated with the user from the data store and sends the portion of information to the wrapper application of the slave device, which passes the data to the second application. If the application is not authorized to read data from the data store, the master device may send an error message to the wrapper application on the slave device. In this manner, a master device provides a method of data sharing among a plurality of applications executing on a slave device. The master device may provide data sharing simultaneously for multiple users on multiple slave devices.

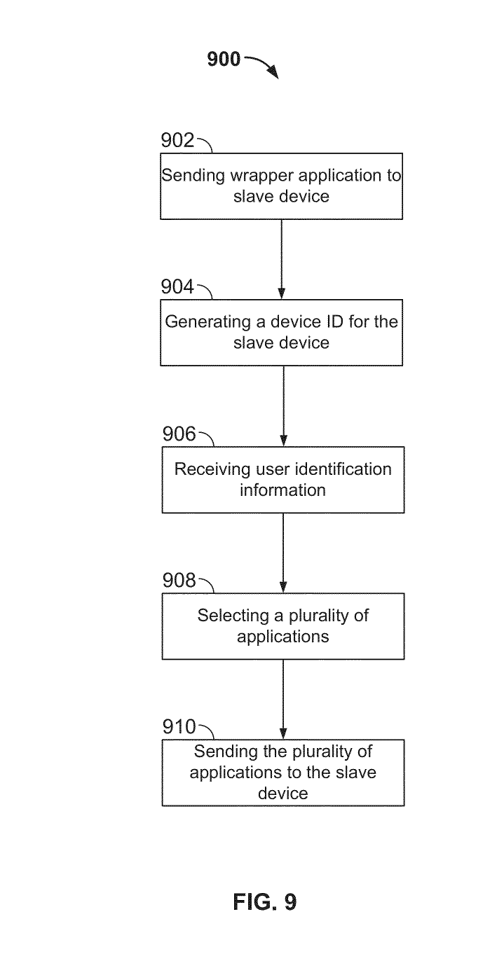

The master device stores user profiles for users accessing the control platform of the master device. When a user logs into the control platform, the master device provides the user with a number of applications to the user's slave device, where the applications that are presented may depend on certain attributes. These attributes may include one or a combination of criteria including the identity of the user, the device unique identifier, and the application unique identifier or version number. FIG. 9 shows a method of providing an application platform for a slave device. Method 900 includes sending from a master device to the slave device a wrapper application to be executed on the slave device and generating a device unique identifier associated with the slave device. The method further includes receiving user identification information from the wrapper application on the slave device, where a user on the slave device inputs the user identification information to the wrapper application. The method further includes selecting a plurality of applications from an application database stored on the master device, where the selection is based on the user identification information and the device unique identifier, and sending the plurality of applications to the slave device. Method 900 may be performed on any device or set of devices providing a control platform for a number of slave devices, such as master device 214 shown in FIG. 2.

Method 900 begins when a master device sends a wrapper application to be installed and executed on a slave device, shown at 902. This may be in response to the slave device requesting a download and installation of the wrapper application from the master device. The master device may send one or more files to the slave device which, when executed, install the wrapper application on the slave device. The wrapper application that the master device sends may depend on the native operating system of the slave device. For example, specific wrapper applications may be developed for Linux operating systems versus a Windows operating system. The master device may identify the native operating system of the slave device by reflection mechanisms or a slave-initiated communication handshake protocol where the version of the native operating system is provided. The master device may send the appropriate files to the slave device based on the identity of the slave device's native operating system and the version number of the operating system. The wrapper application interfaces with the native operating system of the slave device and provides an application platform for the user.

The master device then generates a device unique identifier for the slave device, shown at 904. The device unique identifier may be a number, a set of characters, or any other unique identification method. The master device may assign the device unique identifier when the slave device downloads a wrapper application to be installed on the slave device. Alternatively, the device unique identifier may be assigned later, for example when the installation of the wrapper application is complete or when the user registers the slave device with the master device. The device unique identifier may be associated with the IP address of the slave device, or other methods for associating a device unique identifier with a particular slave device may be used. The device unique identifier is also associated with one or more entities or users. For example, the master device may provide a device registration web page so that users may register the device and associate the device with a particular user (e.g. John Doe), a location (e.g. home) or an entity (e.g. device is property of C.S.D. University). The device unique identifier may also be associated with a native operating system that is on the slave device. The master device stores the device unique identifiers and its associations in a table on a data store.

After the slave device is assigned a device unique identifier, the master device receives user identification information from the slave device, shown at 906. The user identification information may be a user name and password of a user on the slave device that is logging onto a control platform of the master device or an alternative authentication mechanism including but not limited to random numbers, biometric-based authentication, or pattern-based authentication. The master device authenticates the user identification to verify that the user has an account with the master device. The user account may include a user profile with biographical and relational information about the user. The master device then selects one or more applications from an application database stored on the master device, where the selection is based on the user identification information and the device unique identifier, shown at 908. For example, the user profile may specify that the user belongs to a certain high school or the device unique identifier of the slave device may be associated with the high school. The high school has pre-arranged with the master device for its students to have access to a certain set of applications. The master device then selects this set of applications to provide to the student. In another example, the slave device may select certain applications based on the native operating system of the slave device. There may be different versions of the same application developed for different native operating systems and the master device selects the version appropriate for a particular slave device based on the device unique identifier. In another example, the device unique identifier of the slave device may be associated with a teacher and the user profile may specify that the user is a student of the teacher. The teacher may pre-arrange with the master device to make certain applications available to his or her students, so the master device selects those applications to provide to the user.

Once the master device selects a number of applications based on the user identification information and the device unique identifier, the master device sends the applications to the slave device, shown at 910. The master device may send a copy of the applications to the slave device, where they are displayed to the user on an application platform provided by the wrapper application. The applications may read or write data to the master device in a method similar to that described in relation to FIG. 8. The applications may not be permanently loaded onto the slave device but rather are deleted when the user closes the application platform. Thus when the user re-executes the application platform and logs in, the master device re-sends the applications to the slave device. In this manner, the master device provides a method for providing an application platform for a slave device.

It will be apparent to one of ordinary skill in the art that aspects of the systems and methods described herein may be implemented in many different forms of software, firmware, and hardware in the implementations illustrated in the figures. The actual software code or specialized control hardware used to implement aspects consistent with the principles of the systems and method described herein is not limiting. Thus, the operation and behavior of the aspects of the systems and methods were described without reference to the specific software code—it being understood that one of ordinary skill in the art would be able to design software and control hardware to implement the aspects based on the description herein.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

The control program on the master device and wrapper application on the slave device may support a multi-tenancy and hierarchical software architecture for facilitating different levels of access, as well as mechanisms to support operational user, device, application, and information management features. There may be organization and user-related tiers depending on the usage context of the program, either on the slave device side or the master device side. For example, this system may be leveraged for a small educational organization for classroom or infrastructure management or may be used in a corporate environment. The system may be used in a geographically diverse organization that requires the capability to manage their information technology policies relative to slave devices, users using those devices and programs, applications, and/or application features available to users.

What is claimed is:

1. A system for managing applications on a slave device comprising:
a data store configured to store user data and an application database, and being in communication with a master device;
the master device having:
a communication platform configured to communicate with a slave device, wherein the slave device is associated with a device unique identifier and is operated by a user; and
a control platform configured to provide the slave device with:
a plurality of applications selected from the application database based on the device unique identifier and an identity of the user; and
a wrapper application to be executed on the slave device for receiving control commands from the control platform to control the user's access to the plurality of applications and for communicating information between the plurality of applications and the data store.

2. The system of claim 1, wherein each application in the plurality of applications is associated with an application unique identifier.

3. The system of claim 1, wherein the wrapper application is configured to send data access requests to the master device for a first application in the plurality of applications.

4. The system of claim 1, wherein the slave device provides an application programming interface to allow the wrapper application to execute commands on the slave device.

5. The system of claim 4, wherein wrapper application uses the application programming interface of the slave device to execute the control commands.

6. The system of claim 1, wherein the wrapper application has an application programming interface to allow the plurality of applications to communicate with the wrapper application.

7. The system of claim 1, wherein the control commands include a command to prevent execution of a first application in the plurality of applications.

8. The system of claim 1, wherein the control commands include a command to lock access to one or more features of a first application in the plurality of applications.

9. The system of claim 8, wherein the first application is locked based on a plurality of criteria comprising at least one of a time-dependent criterion, a location-based criterion, an identity-based criterion, and an entity-based criterion.

10. The system of claim 1, wherein the control platform is further configured authorize a connection request from the slave device including at least one of the device unique identifier, the identity of the user, an application unique identifier of a first application in the selected plurality of applications, and an application version number of the first application.

11. The system of claim 1, wherein the data store stores a user profile associated with the user.

12. The system of claim 11, wherein the selection of the plurality of applications from the application database is additionally based on the user profile.

13. The system of claim 11, wherein the user profile comprises at least one of user identification information, user relationship information, user demographic information, user academic information, user career information, user usage history information, user resume information, user financial information, user health information, and user data collected from an external source.

14. The system of claim 13, wherein user relationship information comprises information relating a user to other users, information relating the user to entities, and information relating the user to the slave device.

15. The system of claim 1, wherein the communication module is further configured to communicate with a plurality of slave devices having a respective wrapper application installed thereon.

16. The system of claim 15, wherein the control platform is further configured to communicate control commands to the plurality of slave devices.

17. A method of controlling a plurality of slave devices comprising:
receiving, at a master device, a connection request from each slave device in the plurality of slave devices, wherein the connection request is sent from a wrapper application executing on each slave device;
authenticating the connection request from each slave device;
sending, from the master device, an authorization acknowledgement to the wrapper applications of an authorized set of slave devices in the plurality of slave devices;
sending a first command from the master device to the authorized set of slave devices, wherein the first command allows the execution of a first application on each slave device in the authorized set of slave devices; and
monitoring the execution of the first application on each slave device.

18. The method of claim 17, wherein the connection request includes at least one unique identification of each slave device in the plurality of slave devices.

19. The method of claim 17, the method further comprising sending a second command from the master device to the plurality of slave devices, wherein the second command blocks the execution of the first application on each slave device.

20. The method of claim 19, wherein the second command is sent after a plurality of criteria is satisfied.

21. The method of claim 20, wherein the plurality of criteria includes at least one of a time criterion, a location criterion, and a user criterion.

22. The method of claim 17, wherein the monitoring includes collecting input received by the first application from each slave device.

23. The method of claim 17, wherein the monitoring includes tracking the amount of time the application has been executing on each slave device.

24. The method of claim 17, wherein the authenticating includes determining whether each slave device in the plurality of slave devices is authorized to connect to the master device.

25. The method of claim 17, wherein sending the first command occurs when a predetermined requirement is satisfied, wherein the predetermined requirement is based on at least one of time and the location of each slave device.

26. A method of data sharing among a plurality of applications executing on a first slave device comprising:
receiving, at a master device, a data write request from a wrapper application executing on the first slave device, wherein the data write request originates from a first application on the first slave device and includes a portion of information;
authorizing the data write request from the wrapper application, wherein the portion of information is stored in a data store by the master device and associated with the user;
receiving, at the master device, a first data read request from wrapper application, wherein the first data read request originates from a second application on the first slave device and includes a request for the portion of information; and
authorizing the first data read request from the wrapper application, wherein the master device sends the portion of information stored in the data store to the wrapper application.

27. The method of claim 26, wherein authorizing the data write request includes determining that the first application is authorized to store data associated with the user in the data store.

28. The method of claim 27, wherein the data write request includes an identification of the first application that is used to determine that the first application is authorized to store data associated with the user.

29. The method of claim 26, wherein authorizing the first data read request includes determining that the second application is authorized to read data associated with the user in the data store.

30. The method of claim 29, wherein the first data read request includes an identification of the second application that is used to determine that the second application is authorized to read data associated with the user.

31. The method of claim 26, wherein the data write request and the first data read request include the identification of the slave device.

32. The method of claim 26, wherein the data write request and the first data read request include the identification of the user.

33. The method of claim 26, wherein the wrapper application receives the data write request from the first application and the first data read request from the second application through an application programming interface.

34. The method of claim 26 further comprising:
receiving, at the master device, a second data read request from a wrapper application executing on a second slave device, wherein the second data read request originates from a third application on the second slave device and a request for the portion of information; and
authorizing the second data read request from the wrapper application executing on the second slave device, wherein the master device sends the portion of information stored in the data store to the wrapper application executing on the second slave device.

35. A method of providing applications to a slave device based on user identity and slave device identity comprising:
sending from a master device to the slave device a wrapper application to be executed on the slave device;
generating a device unique identifier associated with the slave device;
receiving user identification information from the wrapper application on the slave device, wherein a user on the slave device inputs the user identification information to the wrapper application;
selecting a plurality of applications from an application database stored on the master device, wherein the selection is based on the user identification information and the device unique identifier;
sending the plurality of applications to the slave device.

36. The method of claim 35, wherein the master device uses the user identification information to find a user profile associated with the user that is stored on the master device, and wherein selecting the plurality of applications is additionally based on the user profile.

37. The method of claim 36, wherein the user profile includes at least one of information associating the user with an organization, information associating the user with another user, and information associating the user with the slave device.

38. The method of claim 36, wherein the user profile includes at least one of user identification information, user relationship information, user demographic information, user academic information, user career information, user usage history information, user resume information, user financial information, user health information, and user data collected from an external source.
